(19) United States
(12) Patent Application Publication
(10) Pub. No.: US 2022/0291645 A1
(43) Pub. Date: Sep. 15, 2022

(54) ARTIFICIAL INTELLIGENCE-BASED SYSTEM AND METHOD FOR INDUSTRIAL MACHINE ENVIRONMENT

(71) Applicant: Shady Al-Zubi, Parkland, FL (US)

(72) Inventor: Shady Al-Zubi, Parkland, FL (US)

(21) Appl. No.: 17/694,102

(22) Filed: Mar. 14, 2022

Related U.S. Application Data
(60) Provisional application No. 63/160,786, filed on Mar. 13, 2021.

(51) Int. Cl. G05B 13/04; G05B 23/02

(52) U.S. Cl. CPC G05B 13/041; G05B 23/0283

(57) ABSTRACT

A system and method for automated optimization of industrial machines and controllers. The disclosed system and method include a monitoring module that collects and evaluates input and output data from a controller coupled to a machine; a system identification trigger module that analyses the input and output data to detect performance and stability deviations based on design specifications of the equipment; a system modeling identification module that identifies dynamics of the equipment based on the input and output data; an adaptation module that adapts the controller to the deviations by modifying parameters and/or structure of the controller; a fitness criteria module that evaluates the modified parameters and/or structure of the controller; and a system update module that integrates the modified parameters and/or structure into the controller/machine.

### CROSS-REFERENCE TO RELATED APPLICATIONS

This application claims priority to the U.S. provisional patent application Ser. No. 63/160,786, filed on Mar. 13, 2021, which is incorporated herein by reference in its entirety.

### FIELD OF INVENTION

The present invention relates to a system and method for automated optimization of industrial machine environment, and more particularly, the present invention relates to an artificial intelligence model based adaptive system and method to improve performance and optimize industrial machine installations.

### BACKGROUND

Automation of the manufacturing and industrial environments is being carried out at a fast pace. The automation includes control systems that control the industrial machines. The control system is processor-based system that include complex algorithms to automate the various operations in an industrial environment. However, the automation can be complex and failures or faults in any machine can halt the production lines. To detect the source of faults or failures, various sensors and algorithms are employed that can check the operations and can detect odds. The data generated by the sensors can be analyzed to find the source of fault or failure in the operation of the machine. However, the machines suffer from performance deterioration, which is endemic throughout the world, especially in high asset value systems. No other pre-failure symptom is more dominant than an incremental deviation from desired performance. This declining performance leads to inferior quality, reduced productivity, wasted resources, and ultimately failure.

Existing attempts to use data analytics of the machine in real-time provide at best insights only. Detection of deviations from the set performance and stability specifications, then finding a control solution requires a system expert, control designer, and other special tools. Such expertise and tools are not always available and come at a cost. In addition, are prohibitively time consuming, results in the worsening of the situation.

Thus, a need is appreciated for a system and method that can provide timely solutions in near real-time at a fraction of the cost.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore to provide near real-time artificial intelligence model based adaptation and remedy of deviations from the set performance and stability specifications in an industrial environment.

It is another object of the present invention that the system and method are cost effective in implementation.

It is still another object of the present invention that the system and method prevent machine failures.

It is yet another object of the present invention that the system and method can be readily available.

It is a further object of the present invention that the system and method can enhance the performance and life of the machine.

It is still a further object of the present invention that the system and method are autonomous.

It is yet a further object of the present invention that wastage of raw materials can be avoided due to deviations in the performance of the machine.

In one aspect, disclosed is a system for automated optimization of industrial machines and controllers, the system comprising a processor and a memory, wherein the system comprises a monitoring module, stored in the memory, which upon execution by the processor, collects and evaluates input and output data from a controller coupled to a machine; a system identification trigger module, stored in the memory, which upon execution by the processor, analyses the input and output data to detect performance and stability deviations based on design specifications of the machine; a system modeling identification module, stored in the memory, which upon execution by the processor, identifies dynamics of the machine based on the input and output data; an adaptation module, stored in the memory, which upon execution by the processor, adapts the controller to the performance and stability deviations by modifying parameters and/or structure of the controller; a fitness criteria module, stored in the memory, which upon execution by the processor, evaluates the modified parameters and/or structure of the controller to obtaining final parameters and/or structure; and a system update module, stored in the memory, which upon execution by the processor, integrates the final parameters and/or structure into the controller.

In one implementation, the system is further configured to implement a method comprising the steps of determining, by the system identification trigger module, the performance and stability deviations; determining, by the system modeling identification module, a module from a plurality of modules that best fits a current condition of the machine, each of the plurality of modules comprises operating parameters and performance metrics of the machine and the controller; and adapting the controller, by the adaptation module, by modifying parameters of the controller based on the model. In certain embodiments, the performance and stability deviations are due to wear and tear in the machine.

In one aspect, disclosed is a method for automated optimization of industrial machines and controllers, the method implemented within a system comprising a processor and a memory, the method comprising the steps of determining, by a system identification trigger module implemented within the system and upon execution by the processor, performance and stability deviations of a machine, the machine coupled to a controller; determining, by a system modeling identification module implemented within the system and upon execution by the processor, a module from a plurality of modules that best fits a current condition of the machine, each of the plurality of modules comprises operating parameters and performance metrics of the machine and the controller; adapting the controller, by an adaptation module implemented within the system and upon execution by the processor, by modifying parameters of the controller based on the model to obtain final parameters; and updating, by a system update module implemented within the system and upon execution by the processor, the controller with the final parameters.

In certain implementations, the performance and stability deviations are due to wear and tear in the machine. The method further comprises the steps of switching the controller, from an auto-mode to a manual mode; and upon updating the final parameters, switching back the controller from the manual mode to the auto-mode.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing an architecture of the disclosed system, according to an exemplary embodiment of the present invention.

FIG. 2 is a system Identification block diagram, according to an exemplary embodiment of the present invention.

FIG. 3 is a control system block diagram, according to an exemplary embodiment of the present invention.

FIG. 4 shows dominant poles locations in the z-plane, according to an exemplary embodiment of the present invention.

FIG. 5 shows frequency response with gain and phase margin, according to an exemplary embodiment of the present invention.

FIG. 6 shows a system step response performance specifications Tr, Tp, TS, Mp, SSe, according to an exemplary embodiment of the present invention.

FIG. 7 is a flowchart illustrating an artificial intelligence model-based adaptation trigger criteria, according to an exemplary embodiment of the present invention.

FIG. 8 is a flowchart illustrating an artificial intelligence model-based adaptation cycle, according to an exemplary embodiment of the present invention.

FIG. 9 is a flowchart illustrating advanced performance and stability-based error triggers, according to an exemplary embodiment of the present invention.

FIG. 10 is a block diagram illustrating an artificial intelligence model, according to an exemplary embodiment of the present invention.

FIG. 11 is a flowchart illustrating the artificial intelligence model, according to an exemplary embodiment of the present invention.

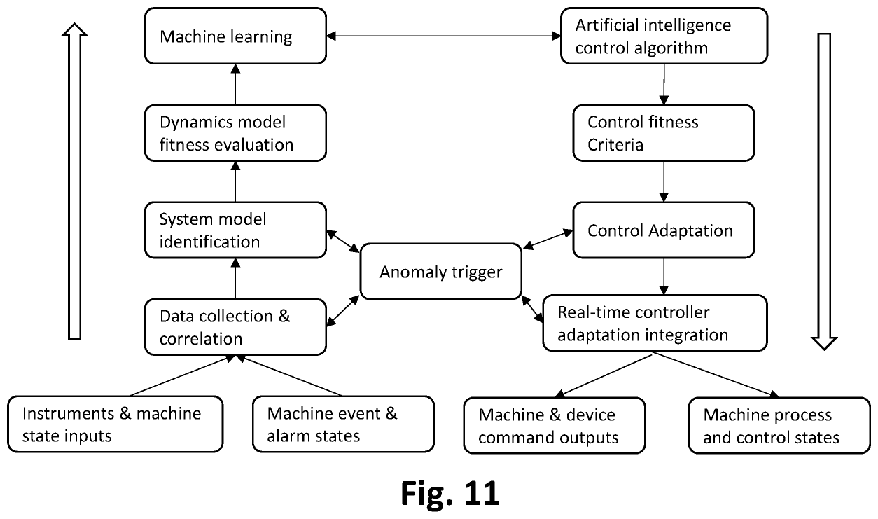

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a system and method for automated optimization of industrial machine environment. The disclosed system and method are an artificial intelligence model based adaptive control system and method to improve performance and optimize industrial machine installations. This disclosed system and method relies on the specific performance data of devices, but not on a generic model of the device during manufacturing design. By implementing the disclosed Al-based intelligent adaptive control system and method, the performance and stability specifications of the machine can be maintained, and degradation in performance and stability can be avoided. This can ultimately prevent failures and maximize on capital and operation investment returns.

The disclosed system can collect, in near real-time, data generated during operations of equipment, machines, devices, and the like in an industrial environment from the onboard instruments. The different equipment, machines, system, devices, and the like in an industrial environment are referred to herein as a machine. This disclosed system can utilize the data to continuously identify the dynamics of the machine and compare it to the original design model of the machine and its specified performance metrics.

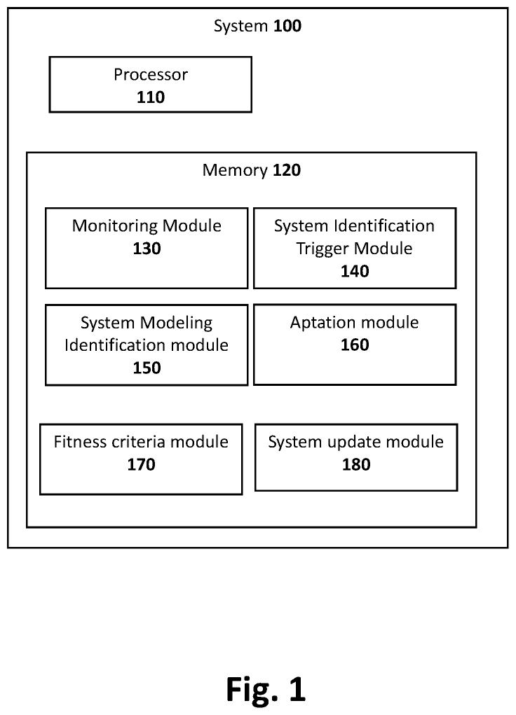

Referring to FIG. 1, which is a block diagram showing an exemplary embodiment of the present invention. The system 100 can include a processor 110 and a memory 120. The processor can be any logic circuitry that responds to, and processes instructions fetched from the memory. The memory may include one or more memory chips capable of storing data and allowing any storage location to be directly accessed by the processor. The memory includes modules according to the present invention for execution by the processor to perform one or more steps of the disclosed methodology. The memory 120 can include a monitoring module 130, a system identification trigger module 140, a system modeling identification module 150, an adaptation module 160, a fitness criteria module 170, and a system update module 180. The monitoring module, upon execution by the processor, can collect and analyze data in near real-time. The system identification trigger module, upon execution by the processor, can detect deviation and violation in machine specification performance or stability or get triggered based on machine specification performance or stability deviation and violation. The system modeling identification module, upon execution by the processor, can identify the current system dynamics based on near real-time data. The intelligent adaptation module can be an Al-based control model, which upon execution by the processor, updates and adapts the controller of the machine to the current identified model. The fitness criteria module, upon execution by the processor, can evaluate the newly identified model and the adapted controller. The system update module, upon execution by the processor, can perform a seamless update to the controller based on the artificial intelligence based adaptation.

In certain embodiment, the controllers and machine can be operated normally. While the controllers are running and in operation, input and output data from the controllers can be collected and evaluated by the monitoring module 130. The system identification trigger module 140 can then analyze the monitored data continuously for determining performance and stability deviations from the design specifications. The deviations can trigger the Al-based adaptation cycle according to the present invention. This starts with the system modeling identification module 150, which can identify the current machine dynamics based on the near real-time data. Based on the identified model of the machine, the Al-based adaptation module 160 can adapt the controller to the deviation by modifying the controller parameters and/or structure. This new calculated controller algorithm can be evaluated by the fitness criteria module 170. Once fitness criteria can be met, the newly adapted control parameter and/or structure can be seamlessly integrated into the machine for improved performance and stability, by the system update module 180.

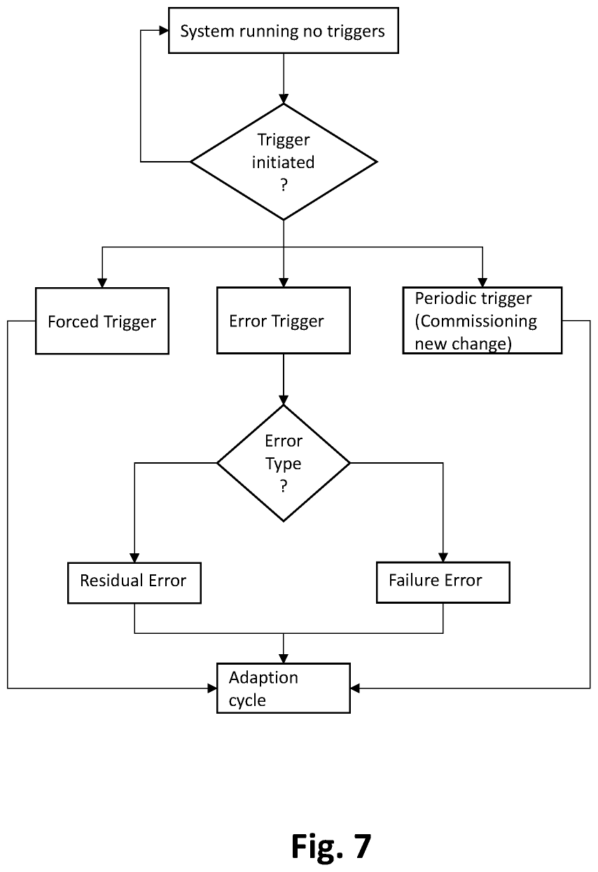

Referring to FIG. 7, which illustrates a continuous residual error can be triggered by the Al-based adaptation. If a predefined small unacceptable error continues for a predefined period of time, an Al-based adaptation cycle can be initiated. The goal of this trigger can be to overcome system performance bias or wear and tear etc. In addition, a sudden large error (failure), the current controller cannot seem to resolve, can also trigger the Al-based adaptation cycle. This can be an attempt to bring back the machine under control with a new set of parameters.

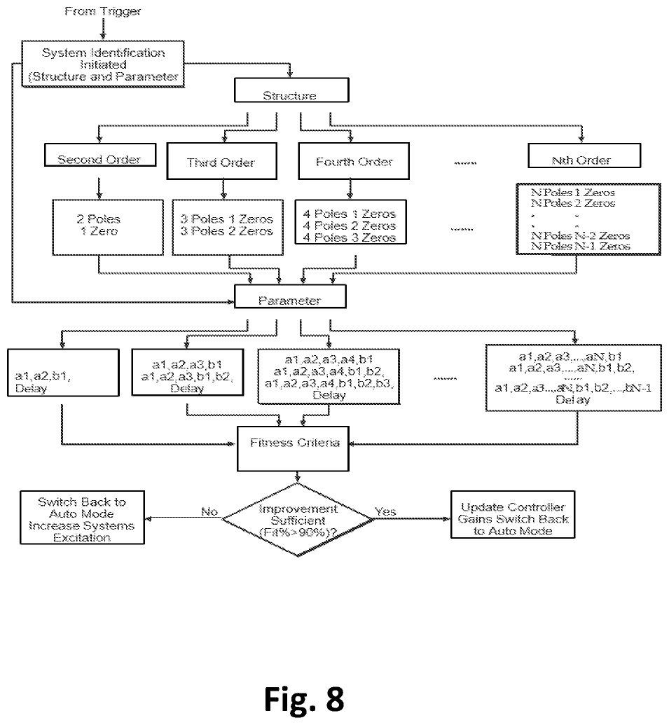

Referring to FIG. 8, which is a flow chart illustrating the disclosed Al-based adaption cycle i.e., the adaption module 160. This adaption module 160 can be executed whenever the adaption cycle is initiated. It includes all the machine's identification and adaptive tuning tasks. Its main function is to analyze the current data and find several machine models for the machine. Once a best fit model can be found, the PID controller tuning can be complimented, and a new set of controller parameters can be written back to the Arduino controller in real-time. In certain embodiment, each time the Al-based adaptation cycle is initiated, the controller can be switched to manual mode for a bump-less transfer. Once completed, the controller can be switched back to auto mode. The machine can resume running with the controller parameters.

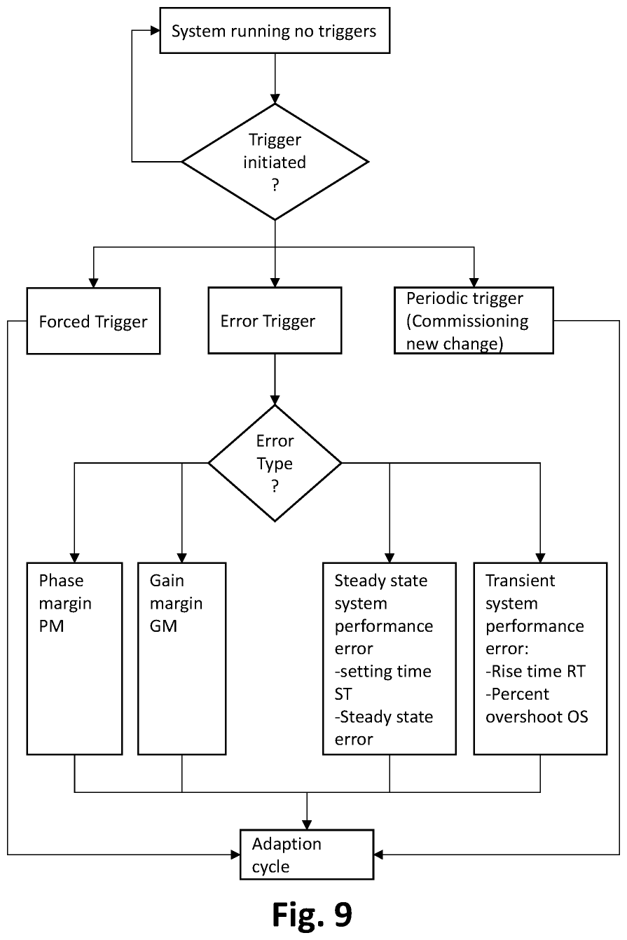

Referring to FIG. 9, which illustrates the trigger-based adaption cycle. In certain implementations, the advanced error triggers with machine specifications can be the point of interest. These errors can trigger the Al-based adaptation cycle based on the performance and stability of the machine as specified in its requirements.

The disclosed system and method can be advantageous by providing continuous mathematical linear and nonlinear modeling of the dynamics of the industrial controllers and machine, continuous monitoring and analysis including machine learning of machine performance and stability metrics, trigger based Al adaptations that are based on specific machine performance, continuous control system Al-based adaptation that can be based on anomaly detection to meet specified performance setpoints and closing the error gap and deviation, and maintaining control system stability with real-time Al-based adaptation.

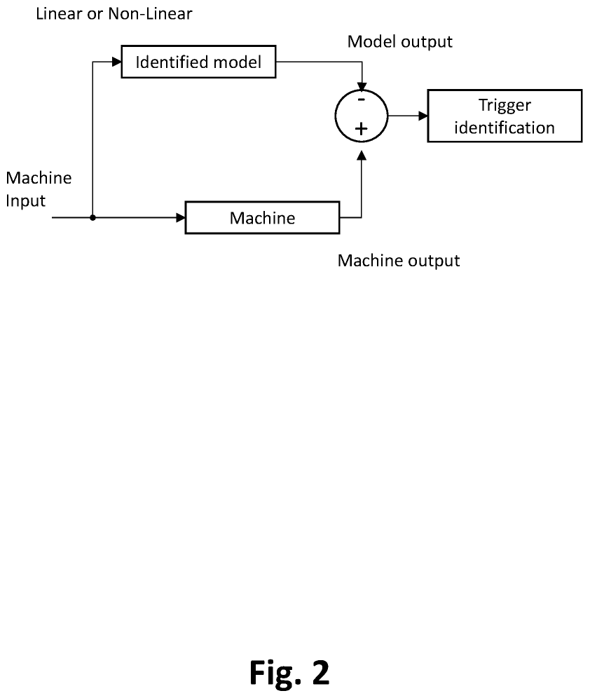

Referring to FIG. 2, which illustrates the continuous mathematical model identification process which involves linear and nonlinear calculated dynamic models to capture the changes to the machine and update the controller to adapt to these changes. Deviation (errors) from performance and stability requirements will trigger identification adaptation cycles.

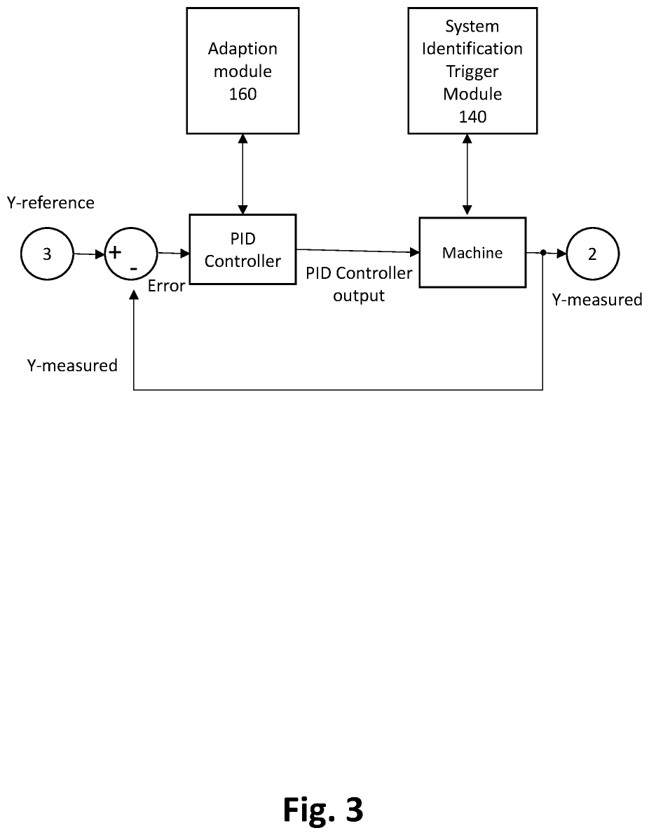

Referring to FIG. 3 which shows a PID closed loop control system with the system modeling identification module connected to the machine for continuous monitoring and identification. The adaptation module is connected to the controller for continuous fitness criteria comparison and adaptation.

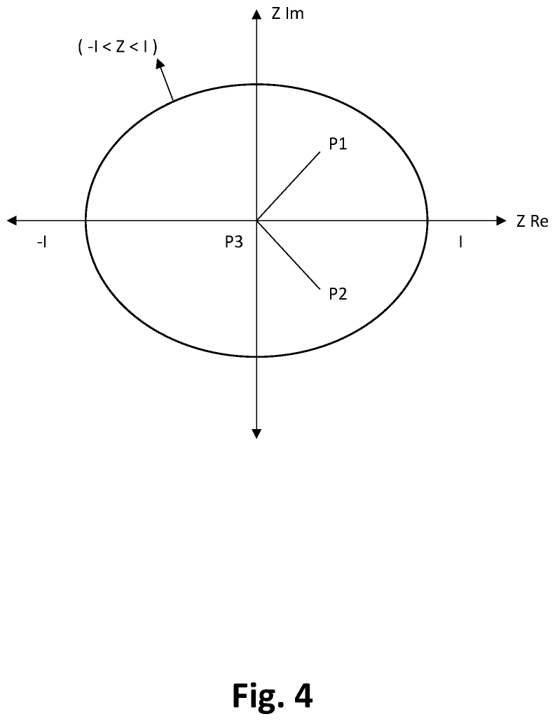

Referring to FIG. 4 which shows the poles and zeros locations as depicted on the z-plane. The poles locations determine the behavior of the system. For calculating the PID gains, first can be chosen the poles to be a dominant conjugate pair and a non-dominant pole (close to the origin). All the poles can be inside the unity circle to ensure stability. Note that the region of convergence ROC in the Z-domain is inside the unity circle and assuming that there is no delay in the machine. Damping ratio and Natural frequency are derived from the poles of the machine.

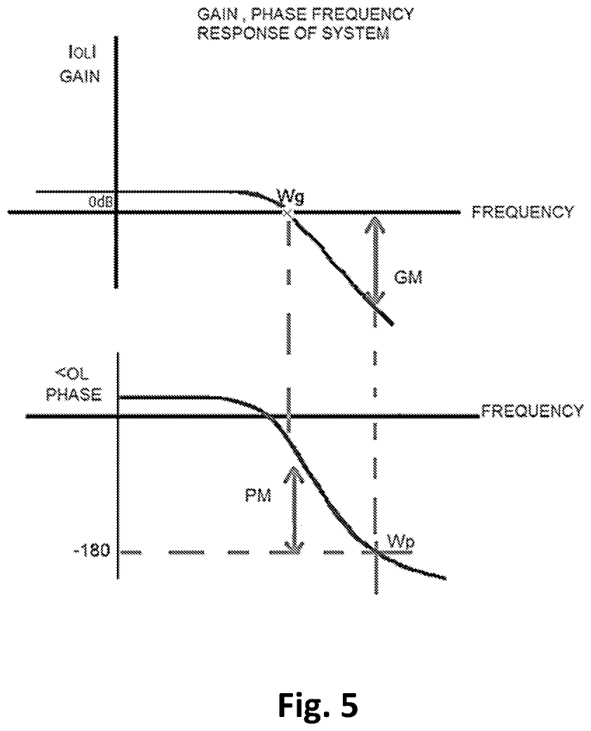

Referring to FIG. 5 which shows Phase Margin PM and Gain Margin GM stability parameters of a machine. PM is the angle of the open loop phase angle at the gain crossover frequency, where the magnitude of the open loop is 0 dB. PM represents the maximum delay or lag in the closed-loop system before it becomes unstable. GM is an insight into how much more forward loop gain that can increase in the closed-loop system before it becomes unstable. It is determined by how far the magnitude of the open loop magnitude is from 0 dB at phase crossover frequency ω_p. For stability specifications as gain margin GM and phase margin PM, the controller PID gains can be calculated. Starting with the identified system model (identified best fit) and parameterized PID, the controller parameters and structure can be updated.

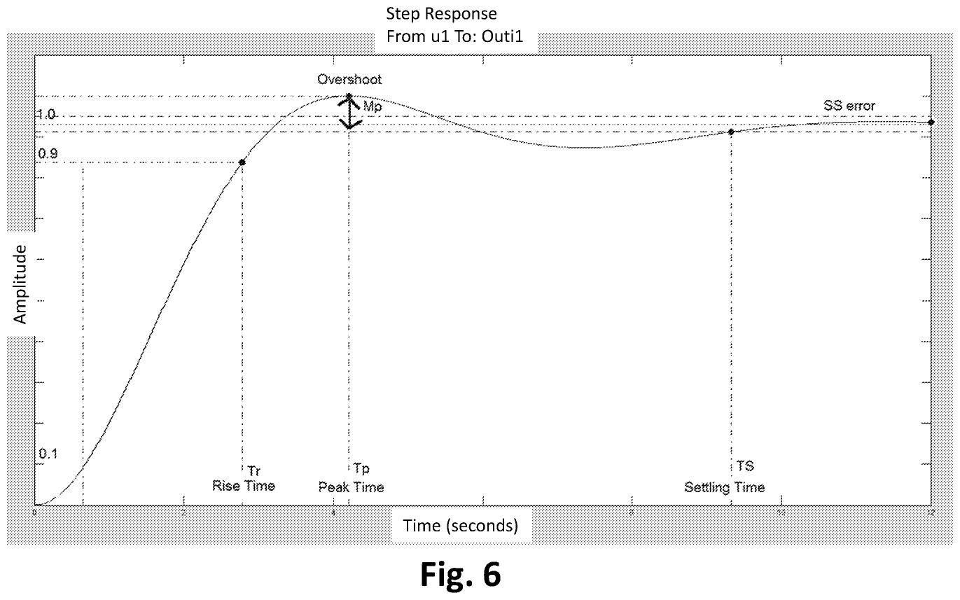

Referring to FIG. 6 which illustrates a Design of a PID Controller Based on Transient and Steady State performance requirements. FIG. 6 shows the transient and steady state parameters of a machine step response characteristics such as rise time, settling time, percent overshoot, steady state error, depending on the application and requirements, the relation between these design parameter requirements and the damping ratio, natural frequency can be determined. Characteristics of a closed loop system with the various performance attributes.

### Transient Performance Parameters

Rise time Tr: Is the time the step response of the system takes from 10% to 90% output value,

Percent overshoot OS: Is the maximum value of the output response of the system minus the step input value divided by the step input value.

### Steady State System Performance Parameters

Settling time TS: Is the time the response of the system takes to reach and stay within a specified range percentage of the final value,

Steady state error SSe: Is the difference between the final response value and the step input value.

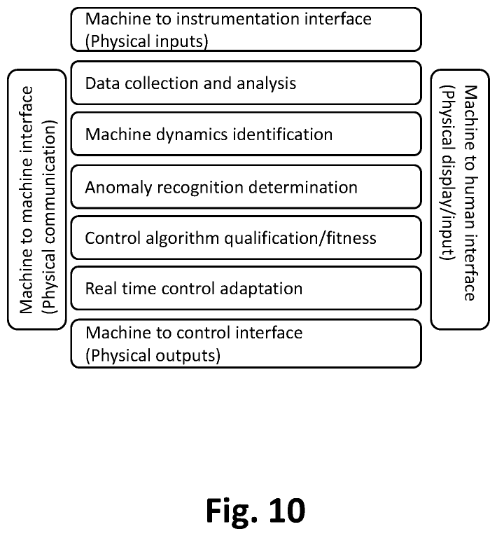

Referring to FIG. 10 which illustrates an exemplary embodiment of the disclosed Al Module that integrates to an existing control system in order to improve its performance, maximize production, minimize operational and maintenance cost. The Al Module includes a self-triggered system identification process that generates different structured and parametrized system models, then qualifies them to determine the best fit model that captures the current dynamics of the physical system. The Al Module also includes a triggered adaptive control module that updates the process controller's parameters through a fitness criteria based on system performance requirements and identified system model.

In certain implementations, a known industrial chemical dosing pump control system integrated with the disclosed Al module can identify and mitigate an anomaly. While in operation, the increase in error (anomaly) triggers the system dynamics model identification. The error led the performance to fall out of specs and run sub-optimally. The error triggered the model identification and subsequently the intelligent control system adaptation to automatically mitigate the error. The newly updated controller can run the dosing pumps efficiently and minimized wasted chemicals due to an earlier error.

In certain embodiment, the disclosed system can monitor the stability and performance requirements of a controller in an industrial environment. For example, a slow bias (Unacceptable steady state error) in performance due to wear and tear results in small residual error. Another error could be a long time to reach setpoint (Unacceptable settling time). These and other errors can trigger the disclosed adaptation module of the machine. If the operator activates a trigger, the adaptation cycle will initiate as well. During the initial commissioning of a control system, for example, a case would be a new control strategy is introduced to the control system for operation. The operator would force an adaptation cycle to learn the new dynamics introduced with the new control strategy.

Also, when the system running time has reached a triggered adaptation period, the adaptation cycle would initiate. The periodic adaptation cycle will continue until the identified model of the newly collected data in the new time period has a good fit, fitness greater than a specified fitness value. This could be particularly valuable when starting up a new system and its permanently tuned parameters take a while before finalizing (Breaking in period). Furthermore, a continuous residual error can trigger an adaptation. If a predefined small unacceptable error continues for a predefined period of time, an adaptation cycle is initiated. The objective of this trigger is to overcome system performance bias or wear and tear etc.

In addition, a sudden large error (failure) the current controller can't seem to resolve can also trigger an adaptation cycle. This would be an attempt to bring back the machine under control with a new set of parameters.

The adaptation module can be called whenever the adaption cycle is initiated. It includes all the system identification and adaptive tasks. Its main function is to analyze the current data and identify several system models for the system. Once the best fit model is found, the PID controller adaptation is complemented, and a new set of controller parameters are written back to the controller in real-time. Each time the adaptation cycle is initiated, the controller is switched to manual mode for a bump less transfer. Once completed the controller is then switched back to auto mode. The machine resumes running with the new controller parameters.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claim is:

1. A system for automated optimization of industrial machines and controllers, the system comprising a processor and a memory, wherein the system comprises:
a monitoring module, stored in the memory, which upon execution by the processor, collects and evaluates input and output data from a controller coupled to a machine;
a system identification trigger module, stored in the memory, which upon execution by the processor, analyses the input and output data to detect performance and stability deviations based on design specifications of the machine;
a system modeling identification module, stored in the memory, which upon execution by the processor, identifies dynamics of the machine based on the input and output data;
an adaptation module, stored in the memory, which upon execution by the processor, adapts the controller to the performance and stability deviations by modifying parameters and/or structure of the controller;
a fitness criteria module, stored in the memory, which upon execution by the processor, evaluates the modified parameters and/or structure of the controller to obtain final parameters and/or structure; and
a system update module, stored in the memory, which upon execution by the processor, integrates the final parameters and/or structure into the controller.

2. The system according to claim 1, wherein the system is further configured to implement a method comprising the steps of:
determining, by the system identification trigger module, the performance and stability deviations;
determining, by the system modeling identification module, a module from a plurality of modules that best fits a current condition of the machine, each of the plurality of modules comprises operating parameters and performance metrics of the machine and the controller; and
adapting the controller, by the adaptation module, by modifying parameters of the controller based on the model.

3. The system according to claim 1, wherein the performance and stability deviations are due to wear and tear in the machine.

4. The system according to claim 2, wherein the method further comprises the steps of:
switching the controller, from an auto-mode to a manual mode; and
upon integrating the final parameters, switching back the controller from the manual mode to the auto-mode.

5. A method for automated optimization of machines and controllers, the method implemented within a system comprising a processor and a memory, the method comprising the steps of:
determining, by a system identification trigger module implemented within the system and upon execution by the processor, performance and stability deviations of a machine, the machine coupled to a controller;
determining, by a system modeling identification module implemented within the system and upon execution by the processor, a module from a plurality of modules that best fits a current condition of the machine, each of the plurality of modules comprises operating parameters and performance metrics of the machine and the controller;
adapting the controller, by an adaptation module implemented within the system and upon execution by the processor, by modifying parameters of the controller based on the model to obtain final parameters; and
updating, by a system update module implemented within the system and upon execution by the processor, the controller with the final parameters.

6. The method according to claim 5, wherein the performance and stability deviations are due to wear and tear in the machine.

7. The method according to claim 5, wherein the method further comprises the steps of:
switching the controller, from an auto-mode to a manual mode; and
upon updating the final parameters, switching back the controller from the manual mode to the auto-mode.
